(19) United States
(12) Patent Application Publication
(10) Pub. No.: US 2019/0384099 A1
(43) Pub. Date: Dec. 19, 2019

(54) DISPLAY PANEL, MANUFACTURING METHOD THEREOF, AND DISPLAY APPLYING THE SAME

(71) Applicants: HKC Corporation Limited; Chongqing HKC Optoelectronics Technology Corporation, Ltd., Chongqing (CN)

(72) Inventor: Yu-Jen CHEN, Chongqing (CN)

(21) Appl. No.: 15/550,614

(22) PCT Filed: May 31, 2017
(86) PCT No.: PCT/CN2017/086651

§ 371 Date: Aug. 11, 2017

(30) Foreign Application Priority Data
May 11, 2017 (CN) 201710332270.6

(51) Int. Cl. G02F 1/1335; G02F 1/1362; G02F 1/1339

(52) U.S. Cl. CPC G02F 1/133514; G02F 1/136227; G02F 2001/13398; G02F 1/1339; G02F 2001/136222; G02F 1/136277

(57) ABSTRACT

This application provides a display panel, manufacturing method thereof, and a display applying the same. The display panel includes a first substrate, a second substrate, and a liquid crystal layer sandwiched between the second substrate and the first substrate, wherein the first substrate includes a first base, a switch array layer disposed on the first base, a color filter layer covering the switch array layer, a first conductive layer disposed on the color filter layer, spacing units, and fillers; the color filter layer includes at least one through hole so as to expose an electrode of the switch array layer; the first conductive layer is in contact with the switch array layer through the through hole; the fillers are filled in the through hole, and a material of the fillers is the same as a material of the spacing units; and the spacing units are formed between the second substrate and the first conductive layer. This application further provides a method for manufacturing the display panel and a display applying the display panel.

### BACKGROUND

### Technical Field

This application relates to the field of display technologies, and in particular, to a display panel, a manufacturing method thereof, and a display applying the same.

### Related Art

When a color filter is directly prepared on an array substrate of a display panel, the color filter includes at least one through hole so as to expose an electrode of a switch array layer. A conductive layer is in contact with the electrode of the switch array layer through the through hole. However, bubbles in the color filter may overflow through the through hole, leading to poor quality of the display panel.

### SUMMARY

In view of the foregoing problem, this application provides a display panel, aiming at resolving, to some extent, a problem of poor quality of the existed display panel.

To resolve the foregoing technical problem, a display panel provided in this application comprises: a first substrate, a second substrate, and a liquid crystal layer sandwiched between the second substrate and the first substrate, where the first substrate comprises a first base, a switch array layer disposed on the first base, a color filter layer covering the switch array layer, a first conductive layer disposed on the color filter layer, fillers, and spacing units; a material of the fillers is the same as a material of the spacing units; the color filter layer comprises at least one through hole so as to expose an electrode of the switch array layer; the first conductive layer is in contact with the switch array layer through the through hole; the fillers are filled in the through hole, and the spacing units are connected between the second substrate and the first conductive layer.

In an embodiment of this application, the fillers have a support height for supporting between the first substrate and the second substrate.

In an embodiment of this application, the switch array layer comprises a first metal layer plated on the first base, an intermediate layer coated on the first metal layer and the first base, and a second metal layer plated on the intermediate layer and the first base; the first conductive layer is accommodated in the through hole and is connected to the second metal layer.

In an embodiment of this application, a protective layer is further comprised and is formed between the color filter layer and the second metal layer; and a passivation layer is formed between the color filter layer and the first conductive layer.

In an embodiment of this application, a material of the protective layer and the passivation layer is silicon nitride or silicon nitride.

In an embodiment of this application, the intermediate layer comprises an insulation layer and an amorphous silicon layer sequentially coated on surfaces of the first metal layer and the first base.

In an embodiment of this application, the second metal layer is a molybdenum-aluminum-molybdenum metal composite layer, a titanium-aluminum-titanium metal composite layer, or a copper-molybdenum metal composite layer.

In an embodiment of this application, a material of the fillers and the spacing units is polyimide.

In an embodiment of this application, the second substrate comprises: a second base; a matrix layer, disposed on the second base; and a second conductive layer, plated on the second base and the matrix layer.

In an embodiment of this application, the spacing units are connected between the first conductive layer and the second conductive layer.

This application further provides a method for manufacturing a display panel, comprising:
providing a first base and forming a switch array layer on the first base;
forming a color filter layer on the switch array layer, wherein the color filter layer comprises at least one through hole;
forming a first conductive layer on the color filter layer, wherein the first conductive layer is in contact with the switch array layer through the through hole;
forming fillers and spacing units, wherein the fillers are filled in the through hole so as to obtain a first substrate;
providing a second substrate, and pairing the second substrate and the first substrate, wherein the spacing units are connected between the second substrate and the first conductive layer; and
injecting liquid crystal into the second substrate and the first substrate to form a liquid crystal layer.

In an embodiment of this application, steps of forming the fillers and the spacing units comprise:
filling the through hole with organic matter, and coating organic matter on a surface of the first conductive layer to form an organic layer; and
performing photoetching processing on the organic layer to form the spacing units and the fillers, wherein the through hole is filled with the fillers, and the spacing units are connected between the second substrate and the first conductive layer.

This application further provides a display, comprising: a drive circuit and a display panel, wherein the display panel comprises a first substrate, the first substrate comprising: a first base; a switch array layer disposed on the first base; a color filter layer covering the switch array layer, wherein the color filter layer comprises at least one through hole so as to expose an electrode of the switch array layer; a first conductive layer, disposed on the color filter layer, and being in contact with the switch array layer through the through hole; spacing units; fillers, filled in the through hole, wherein a material of the fillers is the same as a material of the spacing units; and a passivation layer, formed between the color filter layer and the first conductive layer; and a second substrate, the second substrate comprising: a second base; a matrix layer, disposed on the second base; and a second conductive layer, plated on the second base and the matrix layer.

In an embodiment of this application, a thickness of the first conductive layer is in a range of 0.03 microns to 0.05 microns.

In an embodiment of this application, the spacing units are connected between the second substrate and the second conductive layer.

In an embodiment of this application, a material of the first conductive layer is a transparent or a semi-transparent conductive metal layer.

In this application, a color filter layer comprises at least one through hole so as to expose an electrode of a switch array layer; a first conductive layer is accommodated in the through hole; the first conductive layer is in contact with the switch array layer through the through hole; and the through hole is filled with fillers. Because the through hole is filled with the fillers, bubbles in the color filter layer cannot pass through the through hole to overflow, so that a display panel cannot generate liquid crystal bubbles. Therefore, the display panel has relatively good quality. Further, in this application, spacing units are disposed between the first conductive layer and a second substrate, so that accommodation space for accommodating a liquid crystal layer exists between the first conductive layer and the second substrate.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may still derive other drawings from structures shown in these accompanying drawings without creative efforts.

FIG. 1 is a schematic view of a display panel according to an embodiment of this application;

FIG. 2 is a schematic view of a display panel according to another embodiment of this application; and

FIG. 3 is a flowchart of manufacture of a display panel according to an embodiment of this application.

### DETAILED DESCRIPTION

The following clearly and completely describes the technical solutions in the embodiments of this application with reference to the accompanying drawings in the embodiments of this application. Apparently, the described embodiments are merely some but not all of the embodiments of the present invention. All other embodiments obtained by a person of ordinary skill in the art based on the embodiments of this application without creative efforts shall fall within the protection scope of this application.

It should be noted that all directional indications (such as on, below, left, right, front, back . . . ) are merely used to explain relative position relationships and motions of components in a particular posture (as shown in the accompany drawings). If the particular posture changes, the directional indication correspondingly changes.

In addition, descriptions relating to “first”, “second”, and the like in this application are merely used for a describing objective, and are not to indicate or suggest relative importance or not to implicitly indicate a quantity of indicated technical features. Therefore, features defined with “first” or “second” may explicitly or implicitly include at least one of the features. In addition, the technical solutions of the embodiments may be combined. However, the combination is based on that a person of ordinary skill in the art can implement the combination of the technical solutions. When the combination of the technical solutions are contrary or cannot be implemented, it should be considered that the combination of the technical solutions does not exist and is not within the protection scope of this application.

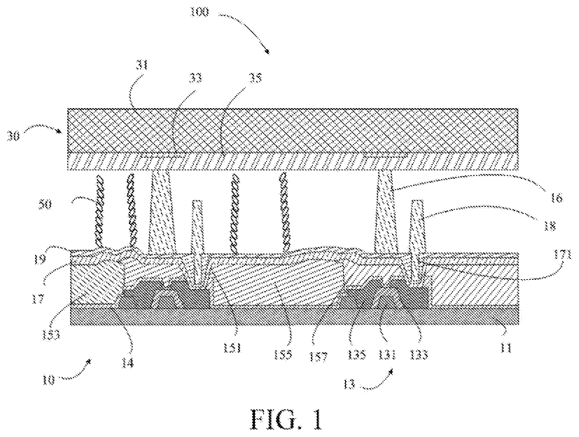

Referring to FIG. 1, this application provides a display panel 100.

The display panel 100 includes a first substrate 10, a second substrate 30, and a liquid crystal layer 50 sandwiched between the second substrate 30 and the first substrate 10. The first substrate 10 includes a first base 11, a thin film transistor (TFT) array layer 13 disposed on the first base 11, a color filter layer 15 covering the first base 11 and the switch array layer 13, a first conductive layer 19 disposed on the color filter layer 15, fillers 18, and spacing units 16. The color filter layer 15 includes at least one through hole 151 so as to expose an electrode of the switch array layer 13. The first conductive layer 19 is in contact with the switch array layer 13 through the through hole 151. The fillers 18 are filled in the through hole 151, and a material of the fillers is the same as a material of the spacing units. The spacing units 16 are connected between the second substrate 30 and the first conductive layer 19.

Optionally, the spacing units 16 and the fillers 18 may be formed at the same time. It may be understood that there are a plurality of fillers 18 and spacing units 16, and preferably, there are two fillers 18 and two spacing units 16.

In this embodiment, the color filter layer 15 includes a plurality of through holes 151, and preferably, there are two through holes 151.

In the technical solution of this application, the color filter layer 15 includes at least one through hole 151 so as to expose the electrode of the switch array layer 13; the first conductive layer 19 is accommodated in the through hole 151; the first conductive layer 19 is in contact with the switch array layer 13 through the through hole 151; and the through hole 151 is filled with the fillers 18. Because the through hole 151 is filled with the fillers 18, bubbles in the color filter layer 15 cannot pass through the through hole 151 to overflow, so that the display panel 100 cannot generate liquid crystal bubbles. Therefore, the display panel 100 has relatively good quality. Further, spacing units 16 are disposed between the first conductive layer 19 and the second conductive layer 35, so that there are appropriate gaps between the first conductive layer 19 and the second conductive layer 35 for accommodating the liquid crystal layer 50.

A material of the fillers 18 and the spacing units 16 may be polyimide.

In the technical solution of this application, a material of the fillers 18 is polyimide, so that the fillers 18 may seal the through hole 151, so as to prevent the bubbles in the color filter layer 15 from passing through the through hole 151 to overflow.

The fillers 18 have a support height for supporting between the first substrate 10 and the second substrate 30.

In the technical solution of this application, the fillers 18 have a support height, so as to enable the fillers 18 to be supported between the first substrate 10 and the second substrate 30, so that accommodation space is formed between the first substrate 10 and the second substrate 30 for accommodating the liquid crystal layer 50.

The color filter layer 15 includes several color resistance units sequentially connected, and every two adjacent color resistance units are partially superposed.

The color filter layer 15 is a color filter, including a first color resistance unit 133 (a red color resistance), a second color resistance unit 135 (a green color resistance), and a third color resistance unit 137 (a blue color resistance).

In the technical solution of this application, for the several color resistance units sequentially connected, every two adjacent color resistance units are partially superposed, so as to provide relatively good color display for the display panel 100.

The switch array layer 13 includes a first metal layer 131 plated on the first base 11, an intermediate layer 133 coated on the first metal layer 131 and the first base 11, and a second metal layer 135 plated on the intermediate layer and the first base 11; the first conductive layer 19 is accommodated in the through hole 151 and is connected to the second metal layer 135.

The first metal layer 131 may include a gate, a gate line, and a common electrode.

The intermediate layer 133 includes an insulation layer and an amorphous silicon layer sequentially coated on surfaces of the first metal layer 131 and the first base 11. The insulation layer is a silicon nitride (SiNₓ) layer or a gate-silicon nitride (G-SiNₓ) layer. The amorphous silicon layer may be an amorphous silicon (α-Si) layer and an N-type amorphous silicon (N⁺α-Si) layer deposited on the amorphous silicon layer.

The second metal layer 135 includes a source and a drain.

In the technical solution of this application, the switch array layer 13 includes the first metal layer 131, the intermediate layer 133, and the second metal layer 135 plated on the intermediate layer and the first base 11, so as to ensure that the display panel 100 can normally work.

The first metal layer 131 is a first metal composite layer, and the first metal composite layer is a molybdenum-aluminum metal composite later, a molybdenum-aluminum alloy composite later, a titanium-aluminum metal composite layer, or a copper-molybdenum metal composite layer.

In the technical solution of this application, the first metal layer 131 may be a composite metal layer, so as to enable the first metal layer 131 with relatively good conductivity.

The second metal layer 135 is a second metal composite layer, and the second metal composite layer is a molybdenum-aluminum-molybdenum metal composite later, a titanium-aluminum-titanium metal composite layer, or a copper-molybdenum metal composite layer.

In the technical solution of this application, the second metal layer 135 may be a composite metal layer, so as to enable the second metal layer 135 with relatively good conductivity.

A protective layer 14 is further formed between the color filter layer 15 and the second metal layer 135, and a passivation layer 17 is further formed between the color filter layer 15 and the first conductive layer 19. A material of the protective layer 14 and the passivation layer 17 is silicon nitride or silicon nitride, that is, SiNₓ, where x is 1 or 4/3.

In the technical solution of this application, the protective layer 14 is further formed between the color filter layer 15 and the second metal layer 135 so as to protect the second metal layer 135. The passivation layer 17 may isolate the color filter layer 15 from the first conductive layer 19.

The second substrate 30 includes a second base 31, a matrix layer 33 disposed on the second base, and a second conductive layer 35 plated on the second base 31 and the matrix layer 33.

The matrix layer 33 may be a black matrix layer.

In the technical solution of this application, the second substrate 30 includes the second base 31, the matrix layer 33, and the second conductive layer 35, so as to ensure that the display panel 100 can normally work.

The spacing units 16 are connected between the first conductive layer 19 and the second conductive layer 35.

It may be understood that there are a plurality of spacing units 16.

In the technical solution of this application, the spacing units 16 are connected between the first conductive layer 19 and the second conductive layer 35, so that accommodation space is formed between the first substrate 10 and the second substrate 20 to accommodate the liquid crystal layer 50.

The material of the first conductive layer 19 and the second conductive layer 35 is a transparent or a semi-transparent conductive metal layer.

A thickness of the first conductive layer 19 is in a range of 0.03 microns to 0.05 microns. The transparent or semi-transparent conductive metal may be indium oxide (In₂O₃), tin oxide (SnO₂), zinc oxide (ZnO), cadmium oxide (CdO), cadmium indium oxide (CdIn₂O₄), cadmium tin oxide (Cd₂SnO₄), zinc tin oxide (Zn₂SnO₄), a mixture of indium oxide and zinc oxide (In₂O₃—ZnO), Tin doped indium oxide (In₂O₃:Sn), or the like.

In the technical solution of this application, a material of the first conductive layer 19 and the second conductive layer 35 is a transparent or semi-transparent conductive metal, so that the first conductive layer 19 and the second conductive layer 35 have relatively good conductivity and have photopermeability.

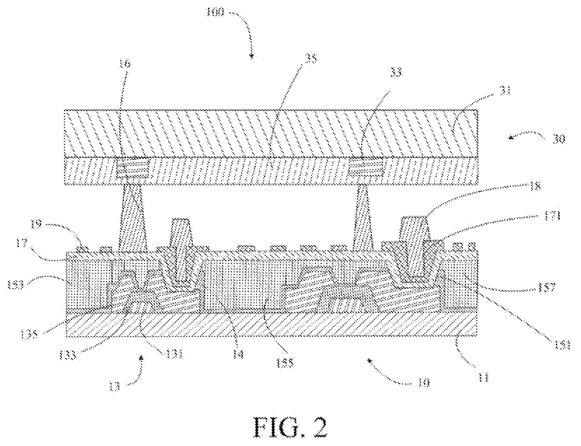

Referring to FIG. 2, this application further provides another display panel 100. In some embodiments, the display panel 100 is of an in-plane switching mode (IPS mode). In another embodiment, the display panel 100 may be of a vertical alignment mode (VA mode).

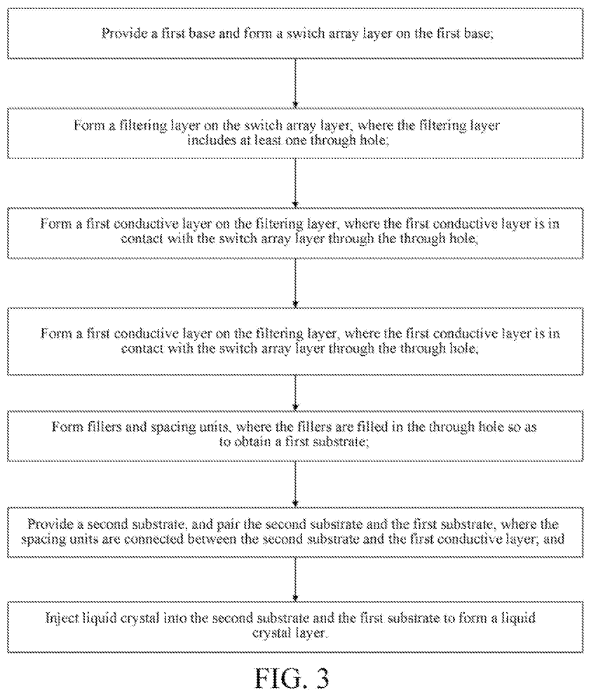

Referring to FIG. 3, this application further provides a method for manufacturing a display panel, including the following steps:
providing a first base 11 and forming a switch array layer 13 on the first base 11;
forming a color filter layer 15 on the switch array layer 13, wherein the color filter layer 15 includes at least one through hole 151;
forming a first conductive layer 19 on the color filter layer 15, wherein the first conductive layer 19 is in contact with the switch array layer 13 through the through hole 151;
forming fillers 18 and spacing units 16, wherein the fillers 18 are filled in the through hole 151 so as to obtain a first substrate 10;
providing a second substrate 30, and pairing the second substrate 30 and the first substrate 10, wherein the spacing units 16 are connected between the second substrate 30 and the first conductive layer 19; and
injecting liquid crystal into the second substrate 30 and the first substrate 10 to form a liquid crystal layer 50.

In this embodiment, the color filter layer 15 includes two through holes 151.

In the technical solution of this application, the color filter layer 15 includes at least one through hole 151 so as to expose an electrode of the switch array layer 13; the first conductive layer 19 is accommodated in the through hole 151; the first conductive layer 19 is in contact with the switch array layer 13 through the through hole 151; and the through hole 151 is filled with the fillers 18. Because the through hole 151 is filled with the fillers 18, bubbles in the color filter layer 15 cannot pass through the through hole 151 to overflow, so that a display panel 100 cannot generate liquid crystal bubbles. Therefore, the display panel 100 has relatively good quality.

A method for preparing the second substrate 30 includes the following steps:
providing a second base 31;
disposing a matrix layer 33 on the second base 31; and
plating a second conductive layer 35 on surfaces of the second base 31 and the matrix layer 33.

In the technical solution of this application, the second substrate 30 includes the second base 31, the matrix layer 33, and the second conductive layer 35, so as to ensure that the display panel 100 can normally work.

Steps of forming the fillers 18 and the spacing units 16 include:
filling the through hole 151 with organic matter, and coating organic matter on a surface of the first conductive layer 19 to form an organic layer, wherein the organic layer may be polyimide; and
performing photoetching processing on the organic layer to form at least one spacing unit 16 and at least one filler 18, where the spacing units 16 are connected between the first conductive layer 19 and the second conductive layer 35, and the through hole 151 is filled with the fillers 18.

It may be understood that there are a plurality of fillers 18 and spacing units 16, and preferably, there are two fillers 18 and two spacing units 16.

In the technical solution of this application, at least one spacing unit 16 is disposed between the first conductive layer 19 and the second conductive layer 35, so that there are appropriate gaps between the first conductive layer 19 and the second conductive layer 35. The fillers 18 are disposed in the through hole 151, so as to prevent bubbles in the color filter layer 15 from passing through the through hole 151 to overflow.

Steps of preparing the color filter layer 15 are:
providing a photoresist;
coating the photoresist on the first base 11 and the switch array layer 13 to form a photoresist film; and
performing photoetching processing on the photoresist film to form several color resistance units, wherein every two adjacent color resistance units are partially superposed.

The filter layer 15 is a color filter, including a first color resistance unit 133 (a red color resistance), a second color resistance unit 135 (a green color resistance), and a third color resistance unit 137 (a blue color resistance).

In the technical solution of this application, for the several color resistance units sequentially connected, every two adjacent color resistance units are partially superposed, so as to provide relatively good color display for the display panel 100.

Steps of preparing the switch array layer 13 are:
plating a first metal layer 131 on the first base 11, and performing photoetching processing on the first metal layer 131 to remove a part of the first metal layer 131;
sequentially depositing an insulation layer and a semiconductor silicon layer on the first metal layer 131 not being removed and the first base 11;
performing photoetching processing on the insulation layer and the semiconductor silicon layer to remove a part of the insulation layer and a part of the semiconductor silicon layer;
plating a second metal layer 135 on the insulation layer that is not removed and the semiconductor silicon layer not being removed; and
performing photoetching processing on the second metal layer 135 to remove a part of the second metal layer 135.

The first metal layer 131 may include a gate, a gate line, and a common electrode.

The intermediate layer 133 includes an insulation layer and an amorphous silicon layer sequentially coated on surfaces of the first metal layer 131 and the first base 11. The insulation layer is a silicon nitride (SiNₓ) layer or a gate-silicon nitride (G-SiNₓ) layer. The amorphous silicon layer may be an amorphous silicon (α-Si) layer and an N-type amorphous silicon (N⁺α-Si) layer deposited on the amorphous silicon layer.

The second metal layer 135 includes a source and a drain.

In the technical solution of this application, the switch array layer 13 includes the first metal layer 131, the intermediate layer 133, and the second metal layer 135 plated on the intermediate layer and the first base 11, so as to ensure that the display panel 100 can normally work.

A protective layer 14 may be formed between the color filter layer 15 and the second metal layer 135. A material of the protective layer 14 and a passivation layer 17 is SiNₓ, where x is 1 or 4/3.

In the technical solution of this application, the protective layer 14 is further formed between the color filter layer 15 and the second metal layer 135 so as to protect the second metal layer 135. The passivation layer 17 may isolate the color filter layer 15 from the first conductive layer 19.

A liquid crystal display device may be a twisted nematic (TN) type device, an optically compensated birefringence (OCB) type device, a vertical alignment (VA) type device, or a curved liquid crystal display device, but is not limited thereto. The liquid crystal display device may use direct backlight. A backlight source may be a white light, an RGB (red+green+blue) three-color light source, an RGBW (red+green+blue+white) four-color light source, or an RGBY (red+green+blue+yellow) four-color light source, but is not limited thereto.

This application further provides a display, and the display includes a drive circuit and the display panel 100. Because all the technical solutions of all the foregoing embodiments are used for the display, the display has at least all beneficial effects brought by the technical solutions of the foregoing embodiments, and details are not described herein.

It may be understood that the display further includes other components for implementing a display function, such as a horizontal polarizer or a vertical polarizer.

The above are merely preferred embodiments of this application, and are not intended to limit the patent scope of this application. All the equivalent structural changes made by using the content of the specification and the accompany drawings of this application under an application concept of this application, or direct or indirect applications in other relevant technical fields all fall within the patent protection scope of this application.

What is claimed is:

1. A display panel, comprising:
a first substrate, comprising:
a first base;
a switch array layer, disposed on the first base;
a color filter layer, covering the switch array layer, wherein the color filter layer comprises at least one through hole so as to expose an electrode of the switch array layer;
a first conductive layer, disposed on the color filter layer, and being in contact with the switch array layer through the through hole;
spacing units; and
fillers, filled in the through hole, wherein a material of the fillers is the same as a material of the spacing units;
a second substrate, wherein the spacing units are connected between the second substrate and the first conductive layer; and
a liquid crystal layer, sandwiched between the second substrate and the first substrate.

2. The display panel according to claim 1, wherein the fillers have a support height for supporting between the first substrate and the second substrate.

3. The display panel according to claim 1, wherein the switch array layer comprises a first metal layer plated on the first base, an intermediate layer coated on the first metal layer and the first base, and a second metal layer plated on the intermediate layer and the first base.

4. The display panel according to claim 3, wherein the first conductive layer is accommodated in the through hole and is connected to the second metal layer.

5. The display panel according to claim 3, further comprising a protective layer, formed between the color filter layer and the second metal layer; and a passivation layer, formed between the color filter layer and the first conductive layer.

6. The display panel according to claim 5, wherein a material of the protective layer and the passivation layer is silicon nitride or silicon nitride.

7. The display panel according to claim 3, wherein the intermediate layer comprises an insulation layer and an amorphous silicon layer sequentially coated on surfaces of the first metal layer and the first base.

8. The display panel according to claim 3, wherein the second metal layer is a molybdenum-aluminum-molybdenum metal composite layer, a titanium-aluminum-titanium metal composite layer, or a copper-molybdenum metal composite layer.

9. The display panel according to claim 1, wherein a material of the fillers and the spacing units is polyimide.

10. The display panel according to claim 1, wherein the second substrate comprises:
a second base;
a matrix layer, disposed on the second base; and
a second conductive layer, plated on the second base and the matrix layer.

11. The display panel according to claim 10, wherein the spacing units are connected between the first conductive layer and the second conductive layer.

12. A method for preparing a display panel, comprising:
providing a first base and forming a switch array layer on the first base;
forming a color filter layer on the switch array layer, wherein the color filter layer comprises at least one through hole;
forming a first conductive layer on the color filter layer, wherein the first conductive layer is in contact with the switch array layer through the through hole;
forming fillers and spacing units, wherein the fillers are filled in the through hole so as to obtain a first substrate;
providing a second substrate, and pairing the second substrate and the first substrate, wherein the spacing units are connected between the second substrate and the first conductive layer; and
injecting liquid crystal into the second substrate and the first substrate to form a liquid crystal layer.

13. The method for preparing a display panel according to claim 12, wherein steps of forming the fillers and the spacing units comprise:
filling the through hole with organic matter, and coating organic matter on a surface of the first conductive layer to form an organic layer; and
performing photoetching processing on the organic layer to form the spacing units and the fillers, wherein the through hole is filled with the fillers, and the spacing units are connected between the second substrate and the first conductive layer.

14. The method for preparing a display panel according to claim 12, wherein a material of the fillers and the spacing units is polyimide.

15. A display, comprising:
a drive circuit; and
a display panel, comprising:
a first substrate, comprising:
a first base;
a switch array layer, disposed on the first base;
a color filter layer, covering the switch array layer, wherein the color filter layer comprises at least one through hole so as to expose an electrode of the switch array layer;
a first conductive layer, disposed on the color filter layer, and being in contact with the switch array layer through the through hole;
spacing units;
fillers, filled in the through hole, wherein a material of the fillers is the same as a material of the spacing units; and
a passivation layer, formed between the color filter layer and the first conductive layer; and
a second substrate, comprising:
a second base;
a matrix layer, disposed on the second base; and
a second conductive layer, plated on the second base and the matrix layer, wherein the thickness of the first conductive layer is in a range of 0.03 microns to 0.05 microns;
the spacing units are connected between the second substrate and the first conductive layer; and
a material of the first conductive layer is a transparent or semi-transparent conductive metal layer.
